(19) United States
(12) Patent Application Publication
(10) Pub. No.: US 2004/0000055 A1
(43) Pub. Date: Jan. 1, 2004

(54) RETRACTABLE KNIFE HAVING BLADE CARTRIDGE

(76) Inventor: Yu Fang Lee Fan, Taichung City (TW)

Correspondence Address: PRO-TECHTOR INTERNATIONAL SERVICES, 20775 Norada Court, Saratoga, CA, 95070-3018, US

(21) Appl. No.: 10/185,349

(22) Filed: Jun. 26, 2002

(51) Int. Cl. B26B 1/08

(52) U.S. Cl. 30/125; 30/162

(57) ABSTRACT

A retractable knife has a blade cartridge removably received in a cavity of handle. The cartridge comprises two clips on top and bottom sides, an elongate top slot, a rear slit two elastic members having top ends urged upward against a bottommost backup blade, a limiting protrusion engaged with a topmost backup blade for preventing it from moving out of rear slit incidentally, and a guide rail engaged with a second topmost backup blade for orderly guiding backup blades toward slot. In an operation, push a push button rearward to move the topmost backup blade out of the slit. Further, in another operation, push clips rearward for removing blade cartridge for replacement.

### FIELD OF THE INVENTION

The present invention relates to retractable knife and more particularly to an improved retractable knife having a blade cartridge.

### BACKGROUND OF THE INVENTION

Retractable knife having blade cartridge is well known. However, one type of commercially available retractable knife having blade cartridge suffered from several disadvantages. For example, its blade cartridge replacement procedure is complicated and time consuming. Also, hand of user is susceptible to hurt by the cutting edge of a backup blade in the blade cartridge if sufficient care is not taken in removing the backup blade from the blade cartridge. In brief, this is not a safe device. Thus improvement exists in order to overcome the above drawbacks of prior art.

### SUMMARY OF THE INVENTION

It is therefore an object of the present invention to provide a retractable knife comprising a handle including an upper handle, a mating lower handle, an internal elongate cavity being open to a rear end, two rectangular rear tongues each transversely extended into a first top opening of the upper handle or a bottom opening of the lower handle, a pair of spaced raised members on an underside of the upper handle adjacent the rear end, a pair of spaced dents on top of the lower handle being matingly engageable with the raised members for fastening the upper and lower handles, a front tongue at the upper handle, a front wall at the lower handle having an opening for permitting the front tongue to insert therein for further fastening the upper and lower handles, an elongate second top opening, and an elongate second top opening on the upper handle; a front blade; a blade push button member; a top blade release button on the upper handle; a push button in the second top opening and including a push block; and a generally parallelepiped blade cartridge including a plurality of backup blades stacked therein, two clips on an underside and a top side being matingly engageable with the rear tongues for fastening the handle and the blade cartridge, an elongate top slot aligned with the second top opening, and a rear slit; wherein in an operation, the push button is pushed rearward along the second top opening to cause the push block to push a topmost one of the backup blades out of the rear slit, and in another operation, the clips are pushed rearward to disengage the clips from the rear tongues for removing the blade cartridge for replacement.

In one aspect of the present invention, the handle further comprises two recesses at both inner side surfaces of the cavity adjacent the dents, and the blade cartridge further comprises two projections on both sides being matingly engageable with the recesses for fastening the handle and the blade cartridge.

In another aspect of the present invention, the blade cartridge further comprises two recesses at both inner side surfaces of the cavity adjacent the dents, and the handle further comprises two projections on both sides being matingly engageable with the recesses for fastening the handle and the blade cartridge.

In still another aspect of the present invention, further comprises a pair of spaced elastic members each having a top end urged against a bottommost one of the backup blades for exerting an upward force thereto and a bottom end secured to the blade cartridge.

In a further aspect of the present invention, the blade cartridge further comprises a limiting protrusion engaged with the topmost one of the backup blades for preventing it from moving out of the rear slit incidentally, and a guide rail engaged with a second topmost one of the backup blades for orderly guiding the backup blades toward the top slot.

The above and other objects, features and advantages of the present invention will become apparent from the following detailed description taken with the accompanying drawings.

### BRIEF DESCRIPTION OF THE DRAWINGS

FIG. 1 is a perspective view of a first preferred embodiment of retractable knife according to the invention with a front portion greatly enlarged;

FIG. 2 is a view similar to FIG. 1 in which a rear portion is greatly enlarged;

FIG. 3 is a cross-sectional view of the rear portion of retractable knife shown in FIG. 2;

FIG. 4 is a cross-sectional view taken along line A-A of FIG. 3;

FIG. 5 is a cross-sectional view taken along line B-B of FIG. 4; and

FIG. 6 is a side view of an elastic member of the retractable knife in part section.

### DETAILED DESCRIPTION OF THE PREFERRED EMBODIMENTS

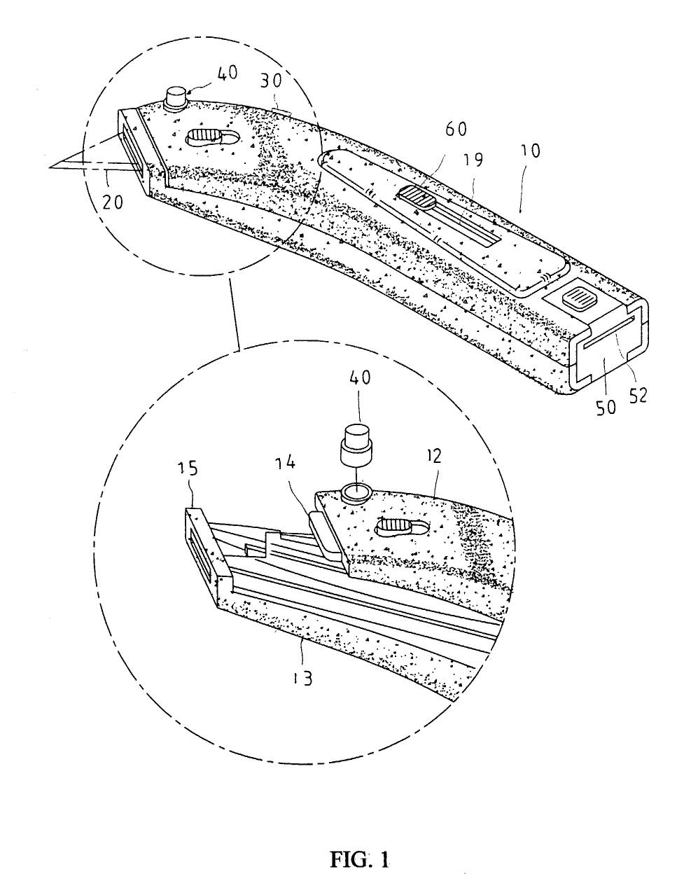

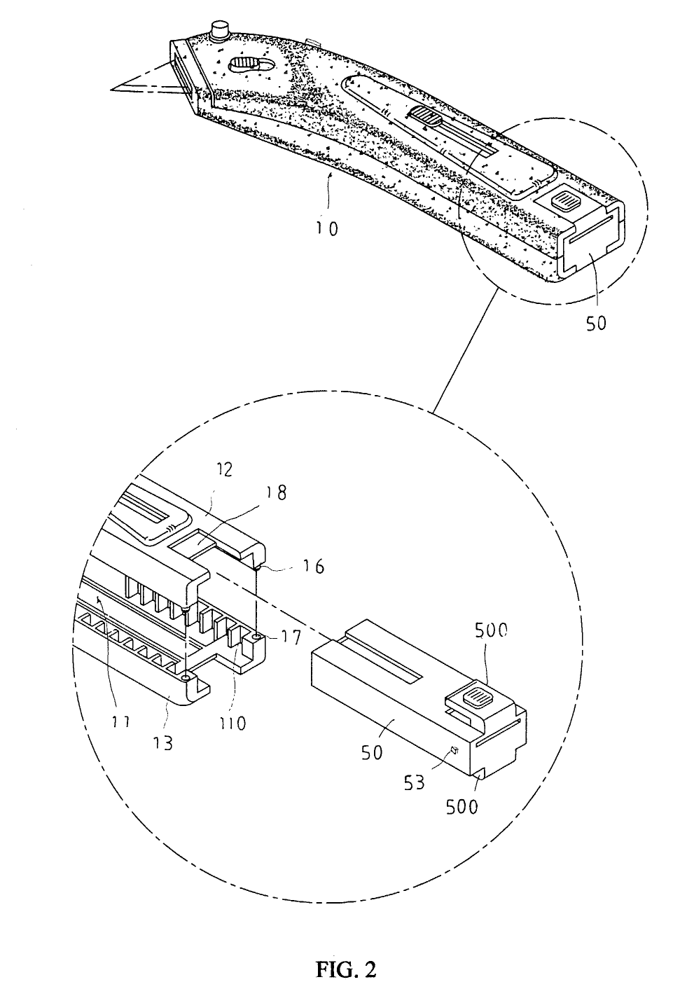

Referring to FIGS. 1 and 2, there is shown a retractable knife constructed in accordance with the invention comprising a handle 10 including an upper handle 12, a mating lower handle 13 (together forming the frame of handle 10), an internal elongate cavity 11 being open to a rear end, two rectangular rear tongues 18 each transversely extended into a top opening of upper handle 12 or a bottom opening of lower handle 13 open to the rear end, a pair of spaced raised members 16 on the underside of upper handle 12 adjacent the rear end, a pair of spaced dents 17 on the top of lower handle 13 being matingly engageable with raised members 16 for fastening upper and lower handles 12 and 13, a recess 110 at either inner side surface of cavity 11 adjacent the dent 17, a front tongue 14 at upper handle 12, a front wall 15 at lower handle 13 having an opening for permitting the front tongue 14 to insert therein for further fastening upper and lower handles 12 and 13, and an elongate opening 19 on top of upper handle 12; a front blade 20; a first push button 30 releasably coupled to heel of blade 20 for either pushing blade 20 forward to extend beyond the opening of front wall 15 in a use state or pushing blade 20 rearward to retract into the handle 10 in a storage state; and a release button 40 on top of upper handle 12 for releasing an inoperable blade 20 for replacement. Both first push button 30 and release button 40 are well known. Thus a detailed description thereof is omitted herein for the sake of brevity.

The retractable knife further comprises a second push button 60 provided in the elongate opening 19 and including a push block 61 (see FIG. 4) and a generally parallelepiped blade cartridge 50 including two clips 500 on the underside and the top side being matingly engageable with rear tongues 18 for fastening handle 10 and blade cartridge 50, and two projections 53 on both sides being matingly engageable with recesses 110 for further fastening handle 10 and blade cartridge 50. Note that positions of recesses 110 and projections 53 may be exchanged, i.e., recesses 110 are provided at blade cartridge 50 and projections 53 are provided at lower handle 13 in other embodiment without departing from the scope and spirit of the invention. The blade cartridge 50 further comprises an elongate top slot 51 aligned with the elongate opening 19 and a rear slit 52.

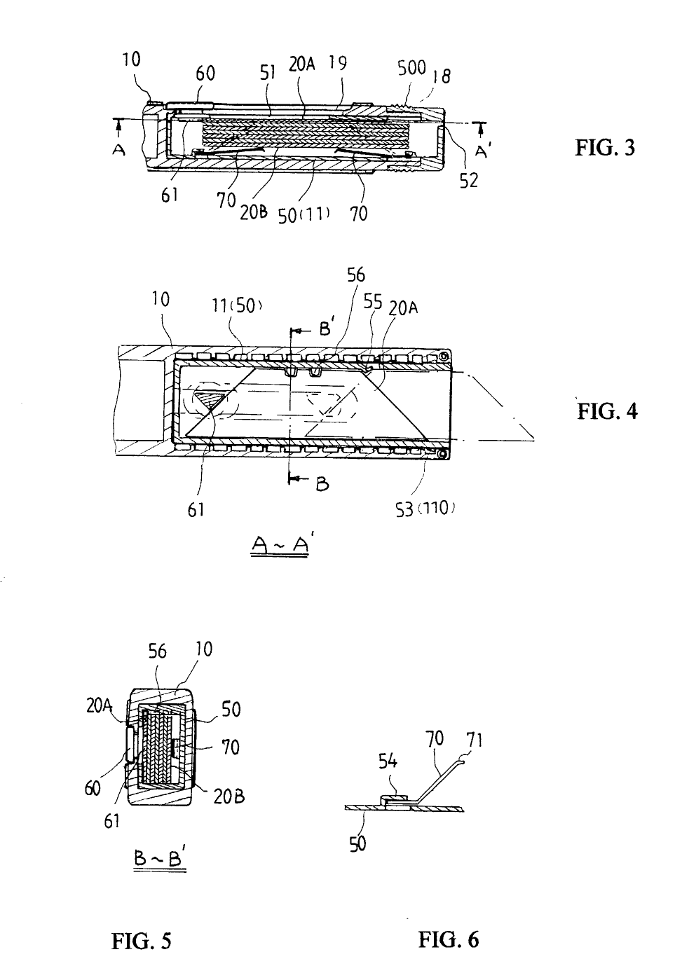

Referring to FIGS. 3 and 6, within the blade cartridge 50 there are provided two opposite lips 54 on the bottom, a limiting protrusion 55 engaged with a topmost backup blade 20A for preventing it from moving out of the rear slit 52 incidentally, and a guide rail 56 engaged with an indent of a second topmost backup blade (note that the provision of indent is well known in a typical blade) for orderly guiding backup blades toward the top slot 51. The retractable knife further comprises a plurality of backup blades (e.g., blades 20A and 20B) stacked in blade cartridge 50 and a pair of spaced elastic members 70 each having a top end 71 urged against the bottommost backup blade 20B so as to exert an upward force to the backup blades and a bottom end secured in the lip 54 for fastening the elastic member 70 onto bottom of blade cartridge 50.

In operating, user can push second push button 60 rearward along the elongate opening 19 to cause the push block 61 to push a topmost backup blade 20A out of rear slit 52 for replacing an inoperable blade 20. Further, user can push knurled protuberances on tops of clips 500 rearward to both disengage projections 53 from recesses 110 and disengage clips 500 from rear tongues 18 so as to remove an empty blade cartridge 50 for replacement.

While the invention has been described by means of specific embodiments, numerous modifications and variations could be made thereto by those skilled in the art without departing from the scope and spirit of the invention set forth in the claims.

What is claimed is:

1. A retractable knife comprising:
a handle including an upper handle, a mating lower handle, an internal elongate cavity being open to a rear end, two rectangular rear tongues each transversely extended into a first top opening of the upper handle or a bottom opening of the lower handle, a pair of spaced raised members on an underside of the upper handle adjacent the rear end, a pair of spaced dents on top of the lower handle being matingly engageable with the raised members for fastening the upper and lower handles, a front tongue at the upper handle, a front wall at the lower handle having an opening for permitting the front tongue to insert therein for further fastening the upper and lower handles, an elongate second top opening, and an elongate second top opening on the upper handle;
a front blade;
a blade push button member;
a top blade release button on the upper handle;
a push button in the second top opening and including a push block; and
a generally parallelepiped blade cartridge including a plurality of backup blades stacked therein, two clips on an underside and a top side being matingly engageable with the rear tongues for fastening the handle and the blade cartridge, an elongate top slot aligned with the second top opening, and a rear slit;
wherein in an operation, the push button is pushed rearward along the second top opening to cause the push block to push a topmost one of the backup blades out of the rear slit, and in another operation, the clips are pushed rearward to disengage the clips from the rear tongues for removing the blade cartridge for replacement.

2. The retractable knife of claim 1, wherein the handle further comprises two recesses at both inner side surfaces of the cavity adjacent the dents, and the blade cartridge further comprises two projections on both sides being matingly engageable with the recesses for fastening the handle and the blade cartridge.

3. The retractable knife of claim 1, wherein the blade cartridge further comprises two recesses at both inner side surfaces of the cavity adjacent the dents, and the handle further comprises two projections on both sides being matingly engageable with the recesses for fastening the handle and the blade cartridge.

4. The retractable knife of claim 1, further comprising a pair of spaced elastic members each having a top end urged against a bottommost one of the backup blades for exerting an upward force thereto and a bottom end secured to the blade cartridge.

5. The retractable knife of claim 1, wherein the blade cartridge further comprises a limiting protrusion engaged with the topmost one of the backup blades for preventing it from moving out of the rear slit incidentally, and a guide rail engaged with a second topmost one of the backup blades for orderly guiding the backup blades toward the top slot.
